(19) United States
(12) Patent Application Publication
(10) Pub. No.: US 2010/0306117 A1
(43) Pub. Date: Dec. 2, 2010

(54) CONSTRUCTION INSPECTION SYSTEM, PORTABLE TERMINAL, CONSTRUCTION INSPECTION METHOD, PROGRAM, AND RECORDING MEDIUM

(75) Inventor: Hajime TERAYOKO, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM CORPORATION, Tokyo (JP)

(21) Appl. No.: 12/790,602

(22) Filed: May 28, 2010

(30) Foreign Application Priority Data
May 29, 2009 (JP) JP2009-131073

(51) Int. Cl. G06Q 50/00; G06Q 10/00; H04N 7/18

(52) U.S. Cl. 705/313; 348/125; 348/E07.091

(57) ABSTRACT

In an embodiment of the present invention, to easily input an association between an evidence photograph and an inspection result on site while obtaining an excellent evidence photograph, a server, a PC, and a portable terminal are used to perform a series of inspection operations including creation of an inspection check sheet, input of an inspection result, imaging of an evidence photograph, and output of a slip. Particularly, the portable terminal can be used to input an inspection point, input an inspection result, image an evidence photograph, determine pass/fail of the evidence photograph, and retake an image. Therefore, the portability and the operability at the inspection site are high, and excellent evidence photographs can be surely obtained at the inspection site. The evidence photographs do not have to be retaken later, and some photographs with unknown quality do not have to be taken for later selection.

### BACKGROUND OF THE INVENTION

1. Field of the Invention

The present invention relates to a system for supporting a construction inspection operation in work such as construction.

2. Description of the Related Art

In relation to a construction inspection operation in work such as building construction, such as inspection for checking the arrangement status of the rebar called bar arrangement inspection, a system for efficiently performing the inspection is conventionally developed.

In Japanese Patent Application Laid-Open No. 2008-146107, a quality management system is used, the system comprising: an inputting device for inputting property information, a construction inspection process, a construction inspection result, an operation progress status, etc.; a storing device for storing and managing inputted information; a communicating device for communicating with a server from a terminal such as a PC through a communication network; an information processing device for executing an application/approval process, etc. of a selection process, an inspection result, etc. of a photograph used as an inspection result; a displaying device for viewing an inspection result, a progress status of work, etc.; and a printing device for outputting a “quality management report”.

In Japanese Patent Application Laid-Open No. 2002-73740, a person in charge of inspecting a property for construction work possesses a property inspection portable terminal device. The terminal device comprises a global positioning system (GPS) that measures geographical location information of the terminal device. Site inspection supporting information is downloaded from a host computer to the terminal device in advance. When the inspector arrives at the site and starts inspecting the property, the global positioning system measures the location of the site and automatically extracts the site inspection supporting information of the property to display the information on the portable terminal device.

In Japanese Patent Application Laid-Open No. 10-25895, an all-processing-sections drawing of a building of an all-processing-sections storing device is displayed on a liquid crystal displaying device, an arbitrary processing section on the all-processing-sections plan view is touched by a touch pen, a center line plan view of individual center line drawing storing device is displayed on the liquid crystal displaying device, one of the inspection part items is designated by the touch pen to plot and display the arrangement locations of bar arrangement inspection parts on the center line plan view of the liquid crystal displaying device, and an arbitrary bar arrangement inspection part is touched by the touch pen to display check items on the liquid crystal displaying device. The bar arrangement work state of the bar arrangement inspection part is confirmed and checked for each check item, and the determination result corresponding to the check result is displayed on a determination field of a check item display screen by use of the touch pen.

In Japanese Patent Application Laid-Open No. 7-254020, a general-purpose electronic notebook is used as an inspection data input device carried by an inspector, an inspection drawing and inspection master data created and edited by a general-purpose personal computer are downloaded to the electronic notebook, and inspection data is directly inputted by the pen touch in the drawings on the screen of the electronic notebook. After the inspection, the inspection data (indicating defective part, defective component, defective status, and company) stored in an IC memory card of the electronic notebook is processed by a personal computer, and various slips are printed and outputted.

Japanese Patent Application Laid-Open No. 2006-19874 is an example of determining defocusing and camera shake of an image.

In “Bar Arrangement Inspection System—Support for Bar Arrangement Inspection by Portable Terminal and Photographic Function —” Technical Research Institute, Obayashi Corporation, Internet URL [http://www.obayashi.co.jp/technology/shoho/pdf/leeflet/3-217.pdf], searched May 14, 2009, a bar arrangement diagram and confirmation items of an inspection part are displayed on a PDA, bar arrangement photographs are managed for each inspection part, and a report including a key plan, a bar arrangement diagram, and work photographs are created.

### SUMMARY OF THE INVENTION

In the evidence photographing of the actual inspection, if an imaged evidence photograph is defective, the inspector needs to retake an evidence photograph on site to surely obtain an excellent evidence photograph. For example, although the bar arrangement inspection is performed before the concrete placement to the frame, if an evidence photograph of the bar arrangement inspection is found out to be defective later, the concrete needs to be destroyed to retake a photograph of the rebar inside. Therefore, the inspector needs to obtain an excellent evidence photograph before the concrete placement.

The conventional techniques do not solve the problem in relation to the acquisition of an excellent evidence photograph by a portable information terminal. Some evidence photographs with unknown quality can be taken, and an excellent evidence photograph can be selected later. However, the operation is cumbersome, and a storage medium capable of storing a large amount of evidence photographs is required.

In view of this, an object of the present invention is to provide a technique which can easily input an association between an evidence photograph and an inspection result on site while obtaining an excellent evidence photograph.

To achieve the above object, the present invention provides a construction inspection system comprising: an inspection check sheet generating apparatus comprising: an inspection content input unit that inputs inspection information related to inspection targets and inspection contents and drawing information related to the inspection information; and an inspection check sheet generating unit that generates an inspection check sheet based on the inspection information and the drawing information inputted by the inspection content input unit; and a portable terminal comprising: a display unit that displays the inspection information and the drawing information based on the inspection check sheet generated by the inspection check sheet generating unit; an inspection target selecting unit that selects a desired inspection target from the inspection targets included in the inspection check sheet in accordance with the drawing information displayed on the display unit; an inspection result input unit that inputs an inspection result corresponding to the inspection content of the inspection target selected by the inspection target selecting unit; an imaging unit that can take an image, in which the inspection target is an object; a pass/fail determination unit that determines pass/fail of an evidence photograph, which is the image taken by the imaging unit, based on a predetermined photographic condition; and a storage unit that can store inspection result data associating the inspection target selected by the inspection target selecting unit, the inspection result inputted by the inspection result input unit, and the evidence photograph determined to be passed by the pass/fail determination unit.

The present invention preferably comprises a slip output unit that converts inspection result data stored in the storage unit into a slip in a predetermined format and that outputs the slip.

The present invention preferably comprises a re-inspection unit that induces re-input of the inspection result and/or retaking of the evidence photograph in accordance with the inspection result included in the inspection result data stored in the storage unit and/or the determination result of the pass/fail determination.

The re-inspection unit preferably displays both the evidence photograph included in the inspection result data stored in the storage unit and an angle of view confirmation image, which is obtained from the imaging unit, on the display unit.

The present invention preferably comprises a notification unit that notifies a predetermined communication device of the inspection result in accordance with the inspection result included in the inspection result data stored in the storage unit.

Preferably, the drawing information inputted by the inspection content input unit includes a sketch drawing and member drawings of the inspection targets including location information on the sketch drawing, the inspection target selecting unit designates a location of an inspection target on the sketch drawing to select the inspection target, and the display unit displays the member drawing of the inspection target selected by the inspection target selecting unit.

Preferably, the portable terminal comprises a photographic point input unit that inputs photographic points of the inspection target selected by the inspection target selecting unit, the storage unit stores inspection result data associating the inspection target selected by the inspection target selecting unit, the inspection result inputted by the inspection result input unit, the photographic point inputted by the photographic point input unit, and the evidence photograph, the inspection information inputted by the inspection content input unit includes a pattern of the photographic points arranged on the member drawing, and the photographic point input unit inputs the photographic points based on a selection of desired photographic points from the pattern of the photographic points arranged on the member drawing displayed by the display unit.

The present invention preferably comprises an output unit that outputs a pass/fail determination result of the pass/fail determination unit.

Preferably, the photographic condition includes at least one of an image resolution, an image size, an image file size, upside/downside information, a luminance, image defocusing information, image blur information, existence of unnecessary objects, a ground levelness, and a readability of characters in the evidence photograph.

The present invention also provides a portable terminal comprising: a display unit that displays inspection information and drawing information based on an inspection check sheet including inspection information related to inspection targets and inspection contents and drawing information related to the inspection information; an inspection target selecting unit that selects a desired inspection target from the inspection targets included in the inspection check sheet in accordance with the drawing information displayed on the display unit; an inspection result input unit that inputs an inspection result corresponding to the inspection content of the inspection target selected by the inspection target selecting unit; an imaging unit that can take an image, in which the inspection target is an object; a pass/fail determination unit that determines pass/fail of an evidence photograph, which is the image taken by the imaging unit, based on a predetermined photographic condition; and a storage unit that can store inspection result data associating the inspection target selected by the inspection target selecting unit, the inspection result inputted by the inspection result input unit, and the evidence photograph determined to be passed by the pass/fail determination unit.

The present invention also provides a construction inspection method for a portable terminal to execute: a step of displaying inspection information and drawing information based on an inspection check sheet including inspection information related to inspection targets and inspection contents and drawing information related to the inspection information; a step of selecting a desired inspection target from the inspection targets included in the inspection check sheet in accordance with the displayed drawing information; a step of inputting an inspection result corresponding to the inspection content of the selected inspection target; a step of taking an image, in which the inspection target is an object; a step of determining pass/fail of an evidence photograph, which is the taken image, based on a predetermined photographic condition; and a step of storing inspection result data associating the selected inspection target, the inputted inspection result, and the evidence photograph determined to be passed.

The present invention also provides a construction inspection program causing a portable terminal to execute the construction inspection method.

The present invention also provides a recording medium in which computer readable code of the above construction inspection program is stored.

According to the present invention, the inspection check sheet generating apparatus and the portable terminal are used to easily perform a series of inspection operations including creation of an inspection check sheet, input of an inspection result, imaging of an evidence photograph, pass/fail determination of the evidence photograph, and output of a slip. Particularly, the portable terminal can be used to input an inspection point, input an inspection result, image an evidence photograph, determine pass/fail of the evidence photograph, and retake an image. Therefore, excellent evidence photographs can be surely obtained at the inspection site. The evidence photographs do not have to be retaken later, and some photographs with unknown quality do not have to be taken for later selection.

### BRIEF DESCRIPTION OF THE DRAWINGS

FIG. 1 is a schematic configuration diagram of a construction inspection system;

FIG. 2 is a diagram showing a summary of a processing content of the construction inspection system;

FIG. 3 is a block diagram of a portable terminal with camera;

FIG. 4 is a flow chart of an inspection check sheet generation process;

FIG. 5 is a flow chart of an inspection operation process;

FIG. 6 is a diagram showing an example of display of a member drawing;

FIG. 7 is a flow chart of a re-inspection process; and

FIG. 8 is a diagram showing an example of display of a framing plan.

### DETAILED DESCRIPTION OF THE PREFERRED EMBODIMENTS

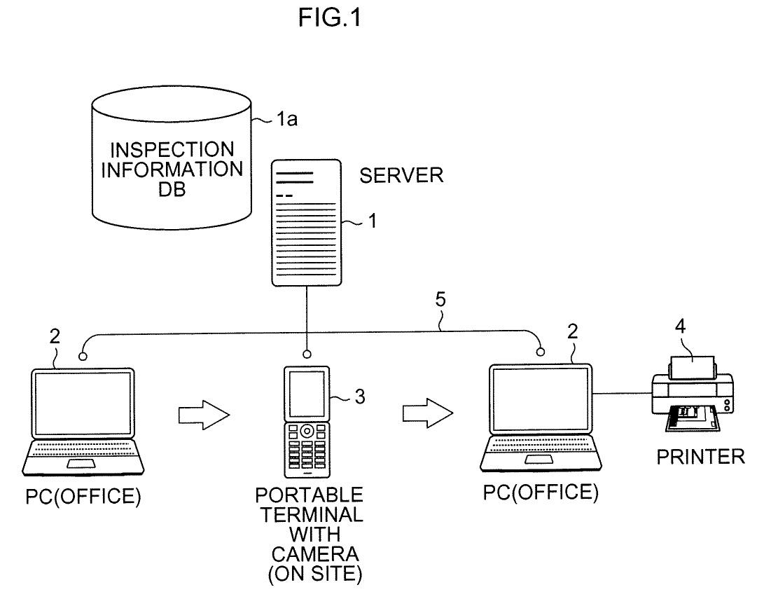

FIG. 1 shows a schematic configuration of a construction inspection system according to a preferred embodiment of the present invention. The system includes a server 1, a personal computer (PC) 2, and a portable terminal with camera 3. The server 1, the personal computer 2, the portable terminal with camera 3, and a printer 4 can be connected to each other through a network 5 formed by a mobile communication network, the Internet, a LAN, etc.

The server 1 comprehensively manages inspection information in an inspection information DB 1a. The server 1 and the personal computer 2 can be constituted by computers (comprising circuits necessary for arithmetic processing, such as CPU, RAM, and ROM, data storage media, data input/output circuits, display circuits, operation devices, communication circuits, etc.). The inspection information DB 1a can be constituted by a high-capacity storage medium such as a hard disk unit.

The inspection information stored in the inspection information DB 1a includes work property names, inspection drawings, inspection types (such as bar arrangement inspection), inspection parts (such as floor number of building), inspection targets (such as pillar, beam, and wall), inspection items (such as type, quantity, and pitch), and inspection points (such as points arranged at equal distances surrounding the cross section of a pillar from the outside). The inspection drawings include a sketch drawing (framing plan) and member drawings (such as bar arrangement diagrams and cross-sectional views). The member drawings and the inspection targets are associated with the locations of the members arranged in the sketch drawing.

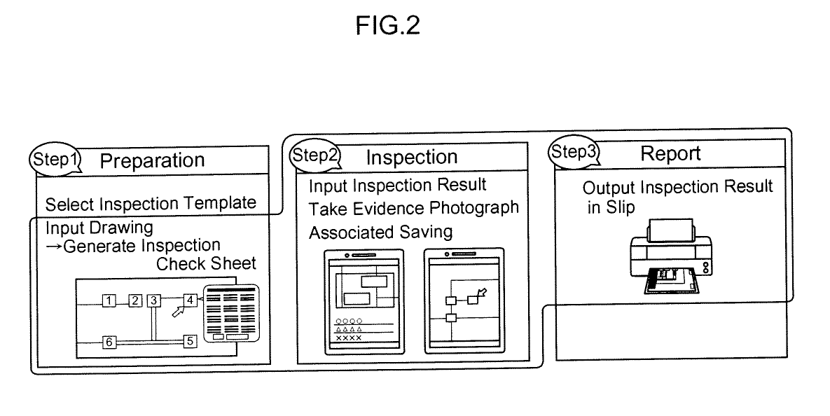

FIG. 2 shows a summary of a processing content of the construction inspection system. In the system, generation of an inspection check sheet (Step 1), input of an inspection result and imaging of an evidence photograph (Step 2), and output of a slip of the inspection result (Step 3) are executed. Specific flows of the processes will be described later.

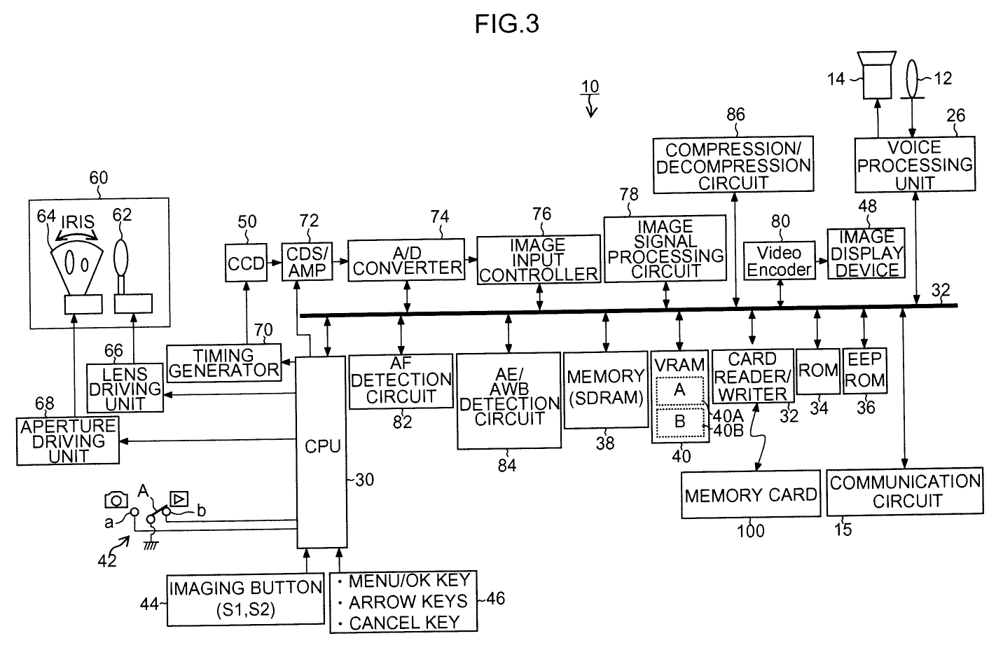

FIG. 3 illustrates a configuration of the portable terminal with camera 3. A central processing unit (CPU) 30 comprehensively controls the entire operation of the portable terminal with camera 3. The CPU 30 functions as a controlling device for controlling the operation in accordance with a predetermined program and functions as a calculating device for carrying out various calculations such as automatic exposure (AE) calculation, auto focus (AF) calculation, and white balance (WB) adjustment calculation.

A ROM 34 connected to the CPU 30 through a bus 32 stores programs executed by the CPU 30, various data necessary for the control, etc. An EEPROM 36 stores CCD pixel defect information, various constants/information related to camera operation, etc.

A memory (SDRAM) 38 is used as a deployment area of the programs and a calculation operation area of the CPU 30 and is used as a temporary storage area of image data and sound data. A VRAM 40 is a temporary storage memory exclusively for image data and includes an A area 40A and a B area 40B. The memory 38 and the VRAM 40 can be shared.

The portable terminal with camera 3 comprises a mode selection switch 42, an imaging button 44, as well as an operating device 46 such as a menu/OK key, arrow keys, and a cancel key. Signals from various operation units (42 to 46) are inputted to the CPU 30. The CPU 30 controls the circuits of the portable terminal with camera 3 based on the input signals and performs, for example, lens drive control, imaging operation control, image processing control, recording/reproducing control of image data, and display control of an image display device 48.

The mode selection switch 42 is an operating device for switching a photographic mode and a reproduction mode. If the mode selection switch 42 is operated to connect a movable armature 42A with a contact point a, the signal is inputted to the CPU 30, and the portable terminal with camera 3 is set to the photographic mode. If the movable armature 42A is connected with a contact point b, the portable terminal with camera 3 is set to the reproduction mode for reproducing recorded images.

The imaging button 44 is an operation button for inputting an instruction for starting photographing and is constituted by two-step stroke type switches including an S1 switch that turns on during the half-press and an S2 switch that turns on during the full-press.

The image display device 48 is constituted by a liquid crystal display capable of color display. The image display device 48 can be used as an electronic finder for checking the angle of view during photographing and is used as a device for reproducing and displaying recorded images. The image display device 48 is also used as a display screen for user interface and displays information such as menu information, selection items, and setting content, as necessary.

When the photographic mode is selected by the mode selection switch 42, power is supplied to an imaging unit including a color CCD solid-state image sensing element (hereinafter “CCD”) 50, and images can be taken.

A lens unit 60 is an optical unit comprising: a photographic lens 62 including a focus lens; and an aperture/mechanical shutter 64. A lens driving unit 66 and an aperture driving unit 68 controlled by the CPU 30 electronically drive the lens unit 60, and zoom control, focus control, iris control are performed.

An image is formed on a light receiving surface of the CCD 50 based on the light passed through the lens unit 60. A multiplicity of photodiodes (light receiving elements) are two-dimensionally arrayed on the light receiving surface of the CCD 50, and primary color filters of red (R), green (G), and blue (B) are arranged in a predetermined array structure (such as Bayer and G stripe) corresponding to the photodiodes. The CCD 50 has an electronic shutter function for controlling the charge storage time (shutter speed) of the photodiodes. The CPU 30 controls the charge storage time in the CCD 50 through a timing generator 70. An image sensing element of another method, such as MOS type, may be used in place of the CCD 50.

The photodiodes convert an object image formed on the light receiving surface of the CCD 50 into signal charge in an amount corresponding to the incident light amount. The signal charge accumulated on the photodiodes is sequentially read out as voltage signals (image signals) corresponding to the signal charge based on the driving pulse provided from the timing generator 70 in accordance with a command of the CPU 30.

The signals outputted from the CCD 50 are transmitted to an analog processing unit (CDS/AMP) 72. The analog processing unit (CDS/AMP) 72 samples and holds (correlated double sampling process) the R, G, and B signals of each pixel and amplifies the signals, and the signals are added to an A/D converter 74. The sequential R, G, and B signals converted into digital signals by the A/D converter 74 are stored in the memory 38 through an image input controller 76.

The image signal processing circuit 78 processes the R, G, and B signals stored in the memory 38 in accordance with a command of the CPU 30. More specifically, the image signal processing circuit 78 functions as an image processing device including a synchronization circuit (processing circuit that interpolates spatial gaps between color signals associated with the single-plate CCD color filter array and that converts the color signals into simultaneous signals), a white balance correction circuit, a gamma correction circuit, a contour correction circuit, and a luminance/color difference signal generation circuit and performs predetermined signal processing using the memory 38 in accordance with the command from the CPU 30.

The image signal processing circuit 78 converts the RGB image data inputted to the image signal processing circuit 78 into luminance signals (Y signals) and color difference signals (Cr and Cb signals) and applies a predetermined process, such as gamma correction, to the data. The image data processed by the image signal processing circuit 78 is stored in the VRAM 40.

To output the image data on the monitor of the image display device 48, the image data is read out from the VRAM 40 and transmitted to a video encoder 80 through the bus 32. The video encoder 80 converts the inputted image data into a signal of a predetermined method for display (for example, color compound video signal of NTSC method) and outputs the image data to the image display device 48.

The image signal outputted from the CCD 50 alternately rewrites the image data, which indicates an image of one frame, between the A area 40A and the B area 40B of the VRAM 40. The written image data is read out from the area other than the area, in which the image data is rewritten, between the A area 40A and the B area 40B of the VRAM 40. In this way, the image data in the VRAM 40 is periodically rewritten, and video signals generated from the image data are supplied to the image display device 48. As a result, a video being taken is displayed on the image display device 48 in real time. The photographer can check the angle of view based on the video (through-movie images) displayed on the image display device 48.

When the imaging button 44 is half-pressed, and S1 is ON, a digital camera 10′ starts an AE and AF process. More specifically, after the A/D conversion, the image signals outputted from the CCD 50 are inputted to an AF detection circuit 82 and an AE/AWB detection circuit 84 through the image input controller 76.

The AE/AWB detection circuit 84 includes a circuit that divides one screen into a plurality of areas (for example, 16×16) and that integrates the RGB signals for each divided area and provides the integrated values to the CPU 30. The CPU 30 detects the brightness (object luminance) of the object based on the integrated values obtained from the AE/AWB detection circuit 84 and calculates an exposure value (imaging EV value) suitable for photographing. The aperture value and the shutter speed are determined in accordance with the obtained exposure value and a predetermined program diagram, and the CPU 30 controls the electronic shutter and the iris of the CCD 50 in accordance with the aperture value and the shutter speed to obtain an appropriate amount of exposure.

During the automatic white balance adjustment, the AE/AWB detection circuit 84 calculates an average integrated value of each color of the RGB signals for each divided area and provides the calculation result to the CPU 30. The CPU 30 obtains an integrated value of R, an integrated value of B, and an integrated value of G to calculate ratios of RIG and B/G in each divided area and determines the light source type based on the distribution, etc. in the color spaces of R/G and B/G of the values of R/G and B/G. In accordance with a white balance adjustment value suitable for the determined light source type, the CPU 30 controls a gain value (white balance correction value) for the R, G, and B signals of the white balance adjustment circuit to make the values of the ratios, for example, substantially 1 (thus, integration ratio of RGB in one screen is R:G:B≅1:1:1) to correct the signals of the color channels.

In the AF control of the digital camera 10′, contrast AF is applied to move the focusing lens (moving lens contributing to the focus adjustment in the lens optical system constituting the photographic lens 62) so that, for example, the high-frequency components of the G signal of the video signal becomes local maximum. More specifically, the AF detection circuit 82 is constituted by a high-pass filter that passes through only the high-frequency components of the G signal, an absolute value processing unit, an AF area extracting unit that cuts out a signal in a focused area set in advance in the screen (for example, center of the screen), and an integrating unit that integrates absolute value data in the AF area.

The CPU 30 is notified of the data of the integrated values obtained by the AF detection circuit 82. The CPU 30 controls the lens driving unit 66 to move the focusing lens to calculate focus evaluation values (AF evaluation values) at a plurality of AF detection points and determines the lens location, in which the evaluation value is local maximum, as the focused location. The CPU 30 then controls the lens driving unit 66 to move the focusing lens to the obtained focused location. The method of calculating the AF evaluation value is not limited to the use of the G signal, and a luminance signal (Y signal) may also be used.

The AE/AF process is executed when the imaging button 44 is half-pressed, and S1 is turned on. The imaging operation for recording starts when the imaging button 44 is full-pressed, and S2 is turned on. The image data acquired in response to the turning on of S2 is converted into a luminance/color difference signal (Y/C signal) in the image signal processing circuit 78, and a predetermined process such as gamma correction is applied to the image data. The image data is then stored in the memory 38. A compression/decompression circuit 86 compresses the Y/C signal stored in the memory 38 in accordance with a predetermined format, and the signal can be recorded in a memory card 100 through a card reader/writer 22. For example, a still image is recorded in a JPEG (Joint Photographic Experts Group) format.

When the reproduction mode is selected by the mode selection switch 42, compressed data of the last image file (file recorded lastly) recorded in the memory card 100 is read out. If the lastly recorded file is a still image file, the read out image compressed data is decompressed into an uncompressed YC signal through the compression/decompression circuit 86. The data is converted into a signal for display through the image signal processing circuit 78 and the video encoder 80 and is then outputted to the image display device 48. As a result, the image content of the file is displayed on the screen of the image display device 48.

The file to be reproduced can be switched (forward/backward) by the operation of a right key or a left key of arrow keys during the reproduction of one frame of the still images (including during the reproduction of the top frame of the moving images). The image file at the forwarded location is read out from the memory card 100, and still images and moving images are reproduced and displayed on the image display device 48 in the same way.

The portable terminal with camera 3 comprises a microphone 12 for inputting sending voices, a speaker 14 for outputting receiving voices, a voice processing unit 26 that encodes the voices inputted from the microphone 12 and that decodes the received voices, and a communication circuit 15 that transfers voices, images and other data to and from the server 1, PC 2, or other portable terminals 3 through a mobile communication network.

The portable terminal with camera 3 can be constituted by a known cell phone with camera, a PDA with camera, etc. The circuits in relation to voice calls may not be included.

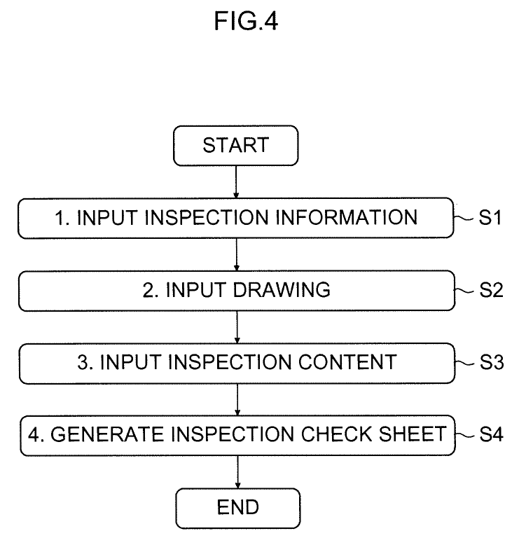

FIG. 4 is a flow chart of an inspection check sheet generation process. The PC 2 accesses the server 1 by the designation of the URL of the server 1 on the web browser and transmits user account information (such as combination of ID and password) to the server 1. The server 1 compares the received user account information and authorized user account information stored in advance in the DB 1a and authenticates the PC 2 based on the comparison result. After the completion of the authentication, the server 1 starts the process in response to an instruction to the PC 2 (such as pressing of dedicated button icon). The programs for the server 1 and the PC 2 to execute the process are stored in the storage media of the server 1 and the PC 2.

In S1, the server 1 transmits an inspection information input screen to the PC 2. The PC 2 receives and displays the screen from the server 1 and receives an input of inspection information along with the screen. The input method of the inspection information is arbitrary, and a text can be inputted by a keyboard or other operation devices, or an item can be selected from a list box. For example, work property name “AA building”, inspection type “bar arrangement inspection”, inspection part “3F”, inspection target member “pillar”, and inspection points “1”, . . . , “9” can be inputted. The PC 2 temporarily stores the inspection information inputted from the operation device in the RAM. A plurality of inspection target members can be inputted.

In S2, the PC 2 receives an input of an inspection drawing in accordance with an instruction on the screen. The inspection drawing can be an output from a CAD application operated on the PC 2 or files following various standards such as PDF and jpeg images. A selection of a desired drawing file from the drawings stored in the PC 2 may be received, and the selected drawing file may be set as the inspection drawing. The PC 2 temporarily stores the inputted inspection drawing in the RAM.

The PC 2 also receives an input of member-related information, which is information for designating the locations on individual member drawings equivalent to the inspection target members inputted in S1 and on the sketch drawing including the inspection target members. More specifically, each inspection target member includes a unique installation location on the sketch drawing and has a unique structure. Therefore, in the present step, the location information indicating the installation locations of the inspection target members on the sketch drawing and the member-related information including the member drawings, which is information for specifying the structures of the inspection target members, are obtained.

In S3, the PC 2 receives an input of the inspection content in accordance with an instruction on the screen. The inspection content is information specifically indicating what kind of item and content will be checked in the inspection, and the data form and the format are arbitrary. Examples of the inspection content include text data describing words such as “type”, “quantity”, and “pitch”, graphic data of a check box accompanying the text data, and a drawing file of a cross-sectional view. The PC 2 temporarily stores the inputted inspection content in the RAM.

In S4, the PC 2 associates the inspection information, the inspection drawings, the member-related information, and the inspection content temporarily stored in the RAM and transmits the information to the server 1.

The server 1 generates an inspection check sheet based on a combination of the information. Specifically, the server 1 first reads out a template stored in advance in the inspection information DB 1a based on the inputted inspection information. For example, based on the information such as inspection type “bar arrangement inspection” and inspection target member “pillar”, the server 1 reads out “template for bar arrangement inspection of pillar” from the inspection information DB 1a.

The template defines the inspection information as well as the arrangement pattern and the display format of the inspection drawings. The template includes first link information that allows cross-reference between the work property name, inspection type, inspection part included in the inspection information and the sketch drawing and second link information that allows cross-reference between the member drawings corresponding to the inspection target members included in the inspection information and the location information of the inspection target members on the sketch drawing. A markup language such as HTML and XML is used in the template to enable the cross-references.

The server 1 fills empty inspection information and inspection drawings in the read out template by the inspection information and the inspection drawings received from the PC 2 to create an inspection check sheet.

Although the sketch drawing is filled in the sketch drawing arrangement location of the template, if the size does not match, the drawing is filled after the sketch drawing is enlarged, reduced, or trimmed within an arbitrary range.

If the member drawings are inputted, the location information of the inspection target members on the sketch drawing are filled in the template based on the location information on the sketch drawing corresponding to the member drawings. The location information is expressed by XY coordinate information on the sketch drawing or by an alternative, such as a center line number.

Although the inspection content is also filled in the inspection content arrangement location of the template, the process can be skipped if the member drawings include the inspection content.

The server 1 stores the created inspection check sheet in the DB 1a.

The entity of the execution of the program for the creation process may be the PC 2 instead of the server 1, and the PC 2, instead of the server 1, can create the inspection check sheet. If the template is in the server 1, the PC 2 requests the server 1 to transmit the template. The PC 2 receives the template and fills in the inputted inspection information, etc. The inspection check sheet created by the PC 2 is transmitted to the server 1 and stored in the DB 1a.

The server 1 then sets the template filled by the inspection information and the inspection drawings as the inspection check sheet.

Although the layout of the inspection information and the inspection drawings defined by the template is arbitrary, the display layout in the portable terminal 3 can be defined, and the print layout in the printer 4 connected to the PC 2 can be defined. Alternatively, applications of the portable terminal 3 and the printer 4 may determine the display layout in the portable terminal 3 and the print layout in the printer 4, respectively.

For the user to check the content of the finished inspection check sheet (sheet in which the inspection result is not filled in), the server 1 may convert the created inspection check sheet into print data printable by the printer 4 to output the sheet to the printer 4, and the printer 4 may print the inspection check sheet.

The server 1 may make the user of the PC 2 or the portable terminal 3, who has logged on the server 1 by the account authority of high-ranked supervisor such as site supervisor, view the content of the finished inspection check sheet and receive an input of approval and rejection. The server 1 may store the content in the DB 1a if the approval is inputted and may not store the content in the DB 1a if the rejection is inputted.

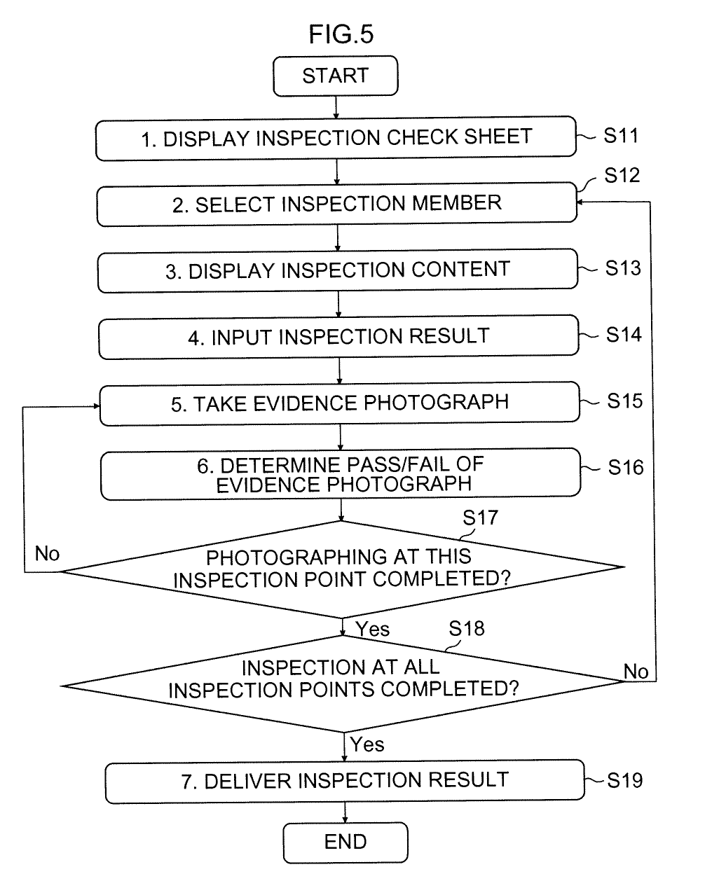

FIG. 5 shows a flow chart of an inspection operation process. Programs for the server 1 and the portable terminal 3 to execute the process are stored in the storage media of the server 1 and the portable terminal 3.

In S11, the portable terminal 3 logs in the server 1 by the authority of the inspector and commands the start of the inspection process. In this case, the inspector carries the portable terminal 3 to the inspection site. If the portable terminal 3 commands the start of the inspection process, the server 1 opens the inspection check sheet stored in the DB 1a and transmits the sheet to the portable terminal 3. If there are a plurality of inspection check sheets stored in the DB 1a, the server 1 transmits an inspection check sheet selected from the portable terminal 3. Alternatively, the server 1 stores the inspection check sheets in the DB 1a in association with the inspection execution date/time and transmits, to the portable terminal 3, the inspection check sheet corresponding to the inspection execution date/time corresponding to or closest to the date/time of the command of the start of the inspection process from the portable terminal 3.

The server 1 may also add the name or the inspection date/time of the logged in inspector to the inspection information to be filled in the inspection check sheet. The access date/time can replace the inspection date/time, and the login user name can replace the name of the inspector.

The server 1 can receive various data from the portable terminal 3 and store the data in the DB 1a in association with the opened inspection check sheet. The timing of the data transmission from the portable terminal 3 to the server 1 is arbitrary. The data may be transmitted every time there is a data input from the portable terminal 3, or the data may be transmitted all together at specific timing such as when the inspection process is finished.

The portable terminal 3 stores the inspection check sheet received from the server 1 in the storage medium such as a RAM and converts the image data of the stored inspection check sheet into a video signal to display the data on the image display device 48. The display method of the inspection check sheet is arbitrary. For example, a viewer screen for displaying a framing plan showing the installation locations of the inspection target members may be used, or a list screen listing the inspection points in the itemized way may be used. The display of the viewer screen and the list screen may be switched each other in accordance with an instruction to the operation device.

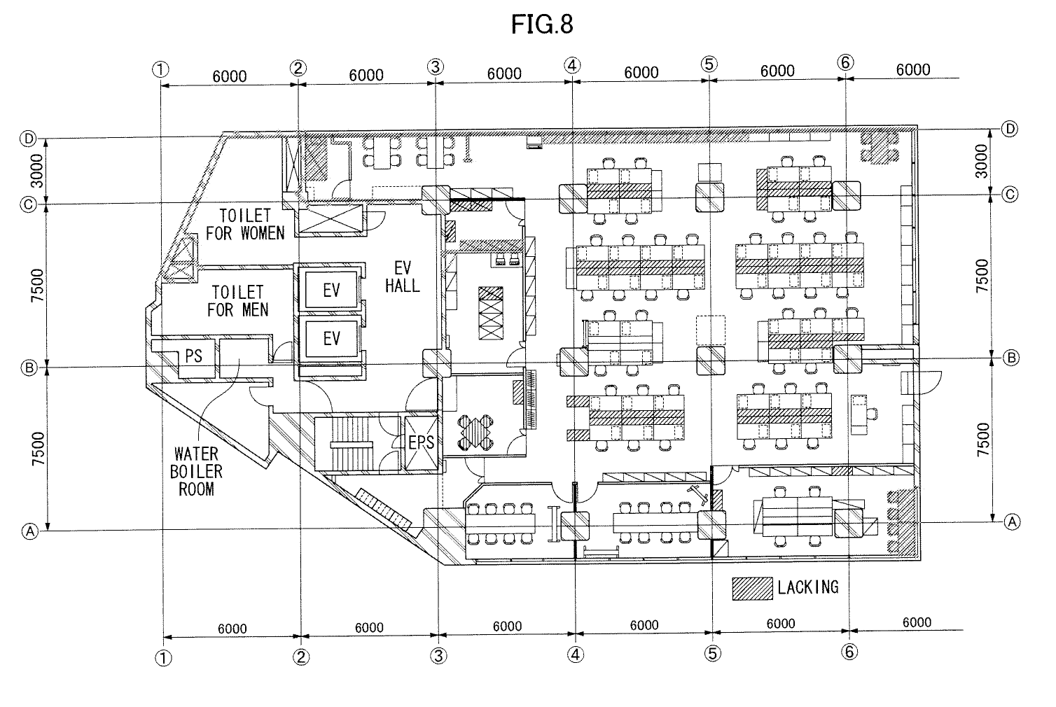

FIG. 8 shows an example of the viewer screen in which the framing plan included in the inspection check sheet received from the server 1 is displayed on the image display device 48 of the portable terminal 3.

In S12, the portable terminal 3 receives a selection of the location of a desired inspection target member from the framing plan displayed on the image display device 48. The selection method is arbitrary. The cursor moves between the inspection target members arranged on the framing plan in accordance with the press of the arrow keys of the operating device 46, and the inspection target member at the cursor location is selected in accordance with the press of an OK key at a desired cursor location. Alternatively, the inspection target member is selected by the press of a number key corresponding to the inspection target member arranged on the framing plan. Alternatively, the inspection target member is selected by designation by the touch of the location of a desired inspection target member among the locations of the inspection target members on the framing plan.

Although in what order the inspection target members will be selected from the plurality of inspection target members is also arbitrary, the order of the inspection target members may be included in the inspection information in advance, and only the selection in accordance with the order may be accepted.

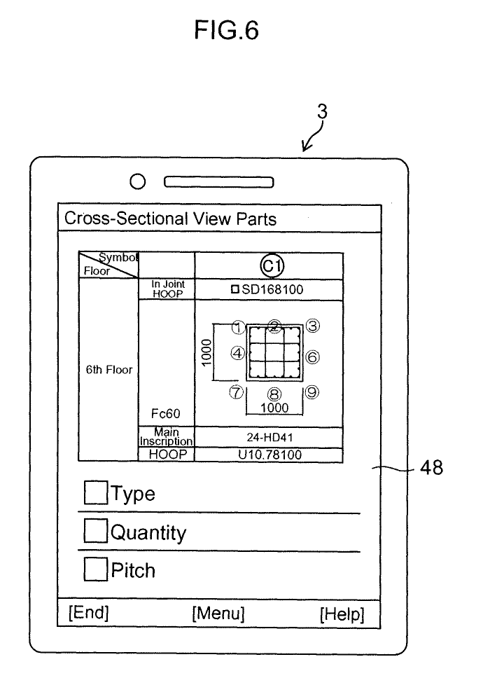

In step S13, the portable terminal 3 displays the inspection content and the member drawing corresponding to the selected inspection target member on the image display device 48. FIG. 6 is an example of the display screen. A cross-section indicating the member of pillar is displayed on the screen along with specific inspection items (such as type, quantity, and pitch of the member). Check boxes for inputting OK or NG of the inspection items are also displayed. One of the patterns of the inspection points corresponding to the selected inspection target member, or in this case, one of inspection points 1 to 9 indicating the imaging directions for seeing the pillar from around the horizontal cross section of the pillar, can be selected by the arrow keys of the operating device 46 or by a pressing operation of a touch panel not shown. The inspection points are not limited to the illustrated points. For example, if the inspection target member is a wall, desired one of the three, left surface of the wall, center, and right side, can be selected. Among the inspection points, inspected points, non-inspected points, and points being inspected may be color-coded and displayed. For example, the inspected points are displayed in blue, the non-inspected points are displayed in red, and the points being inspected are displayed in yellow.

In S14, the portable terminal 3 receives an input of the selection of the inspection point and the inspection result through the operating device 46. In the screen of FIG. 6, an input of the selection of one of the inspection points 1 to 9 and an input of checks indicating whether the type, the quantity, and the pitch of the member are OK or NG can be received. Alternatively, the inspection result may be inputted in text from the operation device, or a voice memo function of the portable terminal 3 may be used to input the speech voice of the inspector or the content of the inspection result or a repair instruction.

In S15, the portable terminal 3 receives, through the imaging button 44, an instruction for photographing an image of the current state of the inspection target member as seen from the selected inspection point. The portable 3 again stores an evidence photograph, which is an image acquired by the memory 38 through the photographing started in accordance with a photographing instruction, in the memory 38 in association with the inspection check sheet, the selected member, and the inspection point.

In S16, the portable terminal 3 compares the photographic conditions stored in the EEPROM 36 and the photographic conditions of the photographed evidence photograph and performs pass/fail determination of the evidence photograph in accordance with the match/mismatch of the conditions. The photographic conditions stored in the EEPROM 36 are arbitrarily set in advance from the operating device 46, etc.

Examples of the photographic conditions stored in the EEPROM 36 include image resolution (for example, more than VGA), image size (for example, 640×480 pixels or more), image file size (for example, more than 500 KB), whether up and down indicating upside/downside information accompanying the image match the actual up and down of the image, whether the luminance of the image keeps a predetermined value, whether there is defocusing (whether the sharpness of image during imaging, or for example, an AF evaluation value, is greater than a predetermined value), whether there is a camera shake (whether the acceleration detected during evidence photographing by the acceleration sensor arranged on the portable terminal 3 is greater than a predetermined value), whether the size of object keeps a predetermined value (for example, whether the horizontal structure line or the vertical structure line has more than a predetermined number of pixels), whether unnecessary object (for example, face of person) is detected, whether the ground is level, and whether the characters in the evidence photograph (for example, blackboard describing photographic information) is readable. The presence of the defocusing and the camera shake can be determined using Japanese Patent Application Laid-Open No. 2006-19874 and other known techniques.

The combination of the types of photographic conditions as standards of the pass/fail determination is also arbitrary. For example, the portable terminal 3 acquires the image resolution, the image size, and the image file size from the property information (stored as header information or tag information) of the image file storing the evidence photograph, reads out the photographic conditions of the types corresponding to them from the EEPROM 36, compares them, and if the entire meta-information fits the photographic conditions of the corresponding types, determines that the evidence photograph is passed.

Alternatively, the portable terminal 3 acquires the image resolution, the image size, the image file size, and the upside/downside information from the meta-information (stored as header information or tag information) of the image file storing the evidence photograph, reads out the photographic conditions of the types corresponding to them from the EEPROM 36, compares them, and if the entire meta-information fits the photographic conditions of the corresponding types, determines that the evidence photograph is passed.

Alternatively, the portable terminal 3 detects luminance information of image, edge information, face, structure line, and characters from the main body of the image data of the image file storing the evidence photograph, reads out the photographic conditions of the types corresponding to them from the EEPROM 36, compares them, and if the entire detection information from the image fits the photographic conditions of the corresponding types, determines that the evidence photograph is passed.

Whether the photographic conditions of the types derived from the evidence photograph or the image file fit the photographic conditions of the corresponding types may be scored (such as 1 point if the conditions match, and 0 point if the conditions do not match), and the pass/fail may be comprehensively determined based on whether the sum of the scores corresponding to the types or the weighted sum reaches a predetermined value. In a word, the method of pass/fail determination is arbitrary as long as some predetermined photographic conditions are used as a standard.

The falsification of the evidence photograph of inspection is strictly restricted in view of the assurance of the credibility of evidence. Therefore, the pass/fail determination has to be based solely on whether the imaged photograph satisfies the photographic conditions, and it is not preferable to perform image processing afterwards to satisfy the photographic conditions. However, the image may be processed if the evidence photograph is used for an application in which a change is permitted. For example, the brightness correction and trimming of an unnecessary peripheral part do not distort the current state of the inspection target and would be permitted.

The portable terminal 3 outputs the result of the pass/fail determination. For example, the portable terminal 3 displays the obtained evidence photograph as well as characters such as “passed” or “failed” indicating the result of the pass/fail determination of the evidence photograph or images such as icons instead of the characters on the image display device 48 and reproduces the voice of “passed” or “failed” by the speaker 14. Alternatively, the vibrator of the portable terminal 3 is activated to output the result to the pass/fail determination only when the photograph is determined to be failed, or only when the photograph is determined to be passed. The inspector can recognize the pass/fail of the evidence photograph by the display, the voice reproduction, or the vibration and can determine whether to take a new evidence photograph or finish photographing.

When the determination of failure is outputted, information, which indicates the reason of the failure based on the photographic conditions that do not match the photographic conditions of the EEPROM 36 among the pieces of information obtained from the evidence photograph or the imaging file storing the evidence photograph, can also be outputted. For example, if the luminance does not satisfy the predetermined value, the portable terminal 3 displays information “brightness is insufficient”, which indicates the reason of the character information failure, on the image display device 48. In this case, the inspector can direct light to the inspection target or emit the flash to strive to obtain an excellent evidence photograph.

In S17, the portable terminal 3 receives a selection of whether imaging of the evidence photograph can be finished, through the operating device 46. If a selection of finishing is inputted, the process proceeds to S18. If a selection of not finishing is inputted, the process returns to S15, and imaging is performed again. The evidence photograph corresponding to the same member and the same inspection point may be singular or plural. Compared to the case in which the inspector repeats taking evidence photographs corresponding to the inspection point one by one and visually checking the photographs, the inspection is more efficient if the inspector takes a plurality of images corresponding to the same inspection point and later selects only necessary images.

Instead of receiving the selection of whether the imaging of the evidence photograph can be finished through the operating device 46, the portable terminal 3 can assume that the selection of finishing imaging of the evidence photograph is inputted if the result of the pass/fail determination is “passed” and proceed to S18. The portable terminal 3 can assume that the selection of not finishing imaging of the evidence photograph is inputted if the result of the pass/fail determination is “failed”, delete the evidence photograph determined to be failed from the memory 38, return to S15, and start a photographic instruction standby operation, i.e., output of movie through images. In this way, if the evidence photograph corresponding to a certain inspection point is determined to be passed, photographing at the inspection point is terminated. Therefore, photographing of unnecessary images can be prevented, and if the photograph is failed, it is possible to prompt the inspector to repeat taking the images until the photograph is passed. Mode setting of whether to perform automatic branching of S18 or S15 may be set from the operating device 46, and the automatic branching may be performed only if the mode setting for the automatic branching is performed. This is because the accuracy of the pass/fail determination is low if the photographic environment is dark and defective, and it may not be preferable to perform the automatic branching.

In S18, the portable terminal 3 determines whether imaging of the evidence photographs corresponding to all inspection target members is finished in accordance with whether the input of the inspection result corresponding to all inspection target members and the input of confirmation of finishing of imaging of the evidence photographs are received through the operating device 46. If it is determined Yes, the process proceeds to S19. If it is determined No, the process returns to S12, the inspection content corresponding to the selected inspection point is displayed, the inspection result is inputted, imaging of the evidence photograph is repeated, and the inspection results and the evidence photographs corresponding to the inspection points are obtained.

In S19, the inspection results of the inspection points are displayed on the image display device 48. The format of display is arbitrary. Although the display of the inspection results is at the end of the process in FIG. 5, the process can be executed at arbitrary timing after the start of the inspection. For example, the inspection result can be displayed at every completion of the evidence photograph of the inspection points.

Alternatively, the status of the inspection result completed so far may be listed and displayed in accordance with an instruction from the user. In this case, if there is an inspection target member for which the input of the inspection result and imaging of the evidence photograph are not finished, the portable terminal 3 can indicate, by the display screen or the voice, the inspection point to notify that the inspection is not completed, and missed inspection can be prevented.

Alternatively, the portable terminal 3 may transmit an email for notifying preset communication partners (server 1, PC 2, and other portable terminals 3) of the completion of the inspection in accordance with the completion of imaging of the evidence photographs corresponding to all inspection target members. Particularly, if the inspection result NG is inputted to a target member, the target member corresponding to the inspection result NG, the inspection point, the content of the inspection result, and the evidence photograph may be put together, and the operating device 46 may notify the portable terminal 3 or the PC 2 of the construction personnel designated in advance of a repair instruction by email and other data communications.

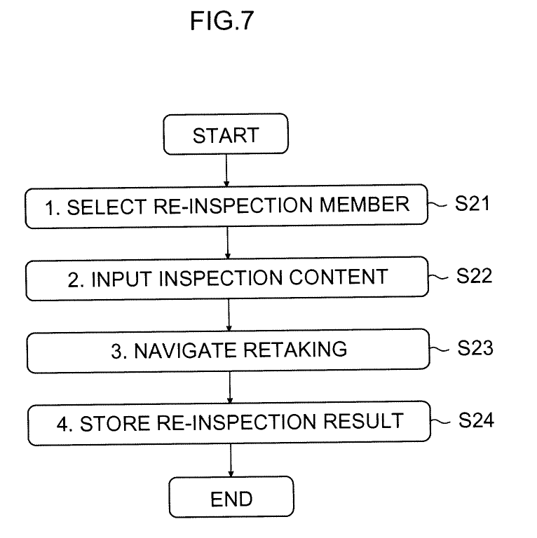

FIG. 7 shows a flow chart of a re-inspection process. Programs for the portable terminal 3 to execute the process are stored in the storage medium of the portable terminal 3. The process can be started if there is at least one inspection target member to which the inspection result of inspection result NG is inputted. The timing of the start of the process is arbitrary. The process may be started in accordance with an input of the inspection result of inspection result NG, or the process may be started immediately after the completion of the inspection operation process.

In S21, the portable terminal 3 receives a selection of a desired inspection target member from the inspection target members, to which the inspection result of inspection result NG is inputted, through the operating device 46. Graphics indicating the inspection target members of the inspection result NG may be shown on the framing plan of the image display device 48. Although this is similar to S12, limiting the selectable inspection target members to the members corresponding to the inspection result of inspection result NG supports the selection of the inspection target member by automatically showing which members are subject to re-inspection.

In S22, the portable terminal 3 displays the member drawings and the inspection contents corresponding to the selected inspection target members on the image display device 48 and receives a selection of the member drawings and the inspection points corresponding to the selected inspection target members through the operating device 46.

In S23, the portable terminal 3 receives an input of the re-inspection result and an instruction of imaging, in which the current state of the re-inspected member is the object, through the operating device 46. The following process is executed to easily compare the states before and after the repair by taking an evidence photograph with the same content (the same location and the same angle) as in the previous inspection. First, in accordance with the instruction to start photographing, the previously taken evidence photographs corresponding to the selected inspection target members are superimposed so that the through-movie images are transparent and displayed on the image display device 48.

This is performed by, for example, detecting basic structure information, such as contours, structure lines, and vanishing points of the objects, from the previous evidence photographs by the edge detection, etc. A known method can be implemented to detect the basic structure information. Next, information other than the structure information detected from the previous evidence photograph is deleted, and the luminance level of the remaining image information is set to a desired luminance level between 0 and 255 (for example, 100). As a result, the basic structure information becomes translucent. The translucent basic structure information is superimposed on the through-movie images. The basic structure information is further detected from the through-movie images, and guide video, which is for instructing the angle of view adjustment so that the same structure information detected from the through-movie images and the previous evidence photographs is located at the same coordinates, (arrow icon indicating the angle of view adjustment direction so that both pieces of structure information match, or icon indicating, on the indicator, the zoom magnification so that both pieces of structure information match) is superimposed. This facilitates the inspector to adjust the angle of view in photographing the member of the re-inspection target in the same structure as the last time.

Alternatively, the previous evidence photographs and the through-movie images may be arranged in the vertical direction or the horizontal direction and displayed on the image display device 48.

In S24, the portable terminal 3 associates the inspection check sheet, the result of the re-inspection, and the newly taken evidence photographs and store them in the memory 38. The previous evidence photographs may be deleted. The stored inspection result and the evidence photographs are transmitted to the server 1 in association with the user ID of the portable terminal 3. The server 1 receives the result and the photographs, associates the inspection check sheet, the inspection result, and the evidence photographs, and stores them in the DB 1a.

The server 1 may fill the inspection result and the evidence photograph, or information (such as hyperlink) substituting the inspection result and the evidence photographs, in the template of the inspection check sheet and store the inspected check sheet as an inspection check sheet in which the inspection result and the evidence photographs are filled. For example, the server 1 may store the information after filling the link information (written by URL, etc.), which is for accessing the inspection result and the evidence photographs disclosed by the web server incorporated into the server 1, in the template of the inspection check sheet transmitted to the portable terminal 3.

The server 1 outputs the stored and inspected check sheet to the outside through the printer 4, the display of the PC 2, or the image display device 48 of the portable terminal 3.

The method for outputting the inspected check sheet is arbitrary. For example, the server 1 lays out the inspected check sheet of XML data in a format of slip in accordance with a predetermined layout conversion rule, such as XSLT, and converts the check sheet into output data, such as PDF, before storing the data. In response to a request from the PC 2, the server 1 transmits the laid out output data to the PC 2. The PC 2 prints out the inspected check sheet received from the server 1 to the printer 4 and displays the check sheet on the display connected to the PC 2 or the image display device 48 of the portable terminal 3.

As described, in the construction inspection system of the embodiment, a desired inspection point can be designated while viewing, in the portable terminal 3, the framing plan and the member drawings included in the inspection check sheet created in advance in the PC 2, the portable terminal 3 can take an evidence photograph corresponding to the designated inspection point, and the inspected check sheet, which is data associating the point and the photograph, can be stored in the server 1. The inspected check sheet stored in the server 1 can be converted into a format of slip before being printed and displayed. Therefore, a series of inspection operations, such as creation of inspection check sheet, input of inspection result, imaging of evidence photograph, and output of slip, can be easily performed using the server 1, the PC 2, and the portable terminal 3. Particularly, the input of inspection point, the input of inspection result, the imaging of evidence photograph, the pass/fail determination of evidence photograph, and retaking of photograph can be performed using the portable terminal 3. Therefore, the portability and the operability at the inspection site are high, and excellent evidence photographs can be surely obtained at the inspection site. The evidence photographs do not have to be retaken later, and some photographs with unknown quality do not have to be taken for later selection.

What is claimed is:

1. A construction inspection system comprising:
an inspection check sheet generating apparatus comprising:
an inspection content input unit that inputs inspection information related to inspection targets and inspection contents and drawing information related to the inspection information; and
an inspection check sheet generating unit that generates an inspection check sheet based on the inspection information and the drawing information inputted by the inspection content input unit; and
a portable terminal comprising:
a display unit that displays the inspection information and the drawing information based on the inspection check sheet generated by the inspection check sheet generating unit;
an inspection target selecting unit that selects a desired inspection target from the inspection targets included in the inspection check sheet in accordance with the drawing information displayed on the display unit;
an inspection result input unit that inputs an inspection result corresponding to the inspection content of the inspection target selected by the inspection target selecting unit;
an imaging unit that can take an image, in which the inspection target is an object;
a pass/fail determination unit that determines pass/fail of an evidence photograph, which is the image taken by the imaging unit, based on a predetermined photographic condition; and
a storage unit that can store inspection result data associating the inspection target selected by the inspection target selecting unit, the inspection result inputted by the inspection result input unit, and the evidence photograph determined to be passed by the pass/fail determination unit.

2. The construction inspection system according to claim 1, further comprising
a slip output unit that converts inspection result data stored in the storage unit into a slip in a predetermined format and that outputs the slip.

3. The construction inspection system according to claim 1, further comprising
a re-inspection unit that induces re-input of the inspection result and/or retaking of the evidence photograph in accordance with the inspection result included in the inspection result data stored in the storage unit and/or the determination result of the pass/fail determination.

4. The construction inspection system according to claim 2, further comprising
a re-inspection unit that induces re-input of the inspection result and/or retaking of the evidence photograph in accordance with the inspection result included in the inspection result data stored in the storage unit and/or the determination result of the pass/fail determination.

5. The construction inspection system according to claim 3, wherein
the re-inspection unit displays both the evidence photograph included in the inspection result data stored in the storage unit and an angle of view confirmation image, which is obtained from the imaging unit, on the display unit.

6. The construction inspection system according to claim 4, wherein
the re-inspection unit displays both the evidence photograph included in the inspection result data stored in the storage unit and an angle of view confirmation image, which is obtained from the imaging unit, on the display unit.

7. The construction inspection system according to claim 1, further comprising
a notification unit that notifies a predetermined communication device of the inspection result in accordance with the inspection result included in the inspection result data stored in the storage unit.

8. The construction inspection system according to claim 6, further comprising
a notification unit that notifies a predetermined communication device of the inspection result in accordance with the inspection result included in the inspection result data stored in the storage unit.

9. The construction inspection system according to claim 1, wherein
the drawing information inputted by the inspection content input unit includes a sketch drawing and member drawings of the inspection targets including location information on the sketch drawing,
the inspection target selecting unit designates a location of an inspection target on the sketch drawing to select the inspection target, and
the display unit displays the member drawing of the inspection target selected by the inspection target selecting unit.

10. The construction inspection system according to claim 8, wherein
the drawing information inputted by the inspection content input unit includes a sketch drawing and member drawings of the inspection targets including location information on the sketch drawing,
the inspection target selecting unit designates a location of an inspection target on the sketch drawing to select the inspection target, and
the display unit displays the member drawing of the inspection target selected by the inspection target selecting unit.

11. The construction inspection system according to claim 9, wherein
the portable terminal comprises a photographic point input unit that inputs photographic points of the inspection target selected by the inspection target selecting unit,
the storage unit stores inspection result data associating the inspection target selected by the inspection target selecting unit, the inspection result inputted by the inspection result input unit, the photographic point inputted by the photographic point input unit, and the evidence photograph,
the inspection information inputted by the inspection content input unit includes a pattern of the photographic points arranged on the member drawing, and
the photographic point input unit inputs the photographic points based on a selection of desired photographic points from the pattern of the photographic points arranged on the member drawing displayed by the display unit.

12. The construction inspection system according to claim 10, wherein
the portable terminal comprises a photographic point input unit that inputs photographic points of the inspection target selected by the inspection target selecting unit,
the storage unit stores inspection result data associating the inspection target selected by the inspection target selecting unit, the inspection result inputted by the inspection result input unit, the photographic point inputted by the photographic point input unit, and the evidence photograph,
the inspection information inputted by the inspection content input unit includes a pattern of the photographic points arranged on the member drawing, and
the photographic point input unit inputs the photographic points based on a selection of desired photographic points from the pattern of the photographic points arranged on the member drawing displayed by the display unit.

13. The construction inspection system according to claim 1, further comprising
an output unit that outputs a pass/fail determination result of the pass/fail determination unit.

14. The construction inspection system according to claim 12, further comprising
an output unit that outputs a pass/fail determination result of the pass/fail determination unit.

15. The construction inspection system according to claim 1, wherein
the photographic condition includes at least one of an image resolution, an image size, an image file size, upside/downside information, a luminance, image defocusing information, image blur information, existence of unnecessary objects, a ground levelness, and a readability of characters in the evidence photograph.

16. The construction inspection system according to claim 14, wherein
the photographic condition includes at least one of an image resolution, an image size, an image file size, upside/downside information, a luminance, image defocusing information, image blur information, existence of unnecessary objects, a ground levelness, and a readability of characters in the evidence photograph.

17. A portable terminal comprising:
a display unit that displays inspection information and drawing information based on an inspection check sheet including inspection information related to inspection targets and inspection contents and drawing information related to the inspection information;
an inspection target selecting unit that selects a desired inspection target from the inspection targets included in the inspection check sheet in accordance with the drawing information displayed on the display unit;
an inspection result input unit that inputs an inspection result corresponding to the inspection content of the inspection target selected by the inspection target selecting unit;
an imaging unit that can take an image, in which the inspection target is an object;
a pass/fail determination unit that determines pass/fail of an evidence photograph, which is the image taken by the imaging unit, based on a predetermined photographic condition; and
a storage unit that can store inspection result data associating the inspection target selected by the inspection target selecting unit, the inspection result inputted by the inspection result input unit, and the evidence photograph determined to be passed by the pass/fail determination unit.

18. A construction inspection method for a portable terminal to execute:
a step of displaying inspection information and drawing information based on an inspection check sheet including inspection information related to inspection targets and inspection contents and drawing information related to the inspection information;
a step of selecting a desired inspection target from the inspection targets included in the inspection check sheet in accordance with the displayed drawing information;
a step of inputting an inspection result corresponding to the inspection content of the selected inspection target;
a step of taking an image, in which the inspection target is an object;
a step of determining pass/fail of an evidence photograph, which is the taken image, based on a predetermined photographic condition; and
a step of storing inspection result data associating the selected inspection target, the inputted inspection result, and the evidence photograph determined to be passed.

19. A construction inspection program causing a portable terminal to execute the construction inspection method according to claim 18.

20. A recording medium in which computer readable code of the construction inspection program according to claim 19 is stored.
